(19) United States
(12) Patent Application Publication
(10) Pub. No.: US 2014/0071152 A1
(43) Pub. Date: Mar. 13, 2014

(54) IMAGE PROCESSING APPARATUS, IMAGE PROCESSING SYSTEM, AND IMAGE PROCESSING METHOD

(71) Applicant: Casio Computer Co., Ltd., Tokyo (JP)

(72) Inventors: Kazuhiro Kashio, Tokyo (JP); Yoshiharu Houjou, Tokyo (JP); Katsuya Sakamaki, Tachikawa-shi (JP)

(73) Assignee: Casio Computer Co., Ltd., Tokyo (JP)

(21) Appl. No.: 14/081,701

(22) Filed: Nov. 15, 2013

Related U.S. Application Data
(62) Division of application No. 13/192,984, filed on Jul. 28, 2011.

(30) Foreign Application Priority Data
Jul. 30, 2010 (JP) 2010-172202

(51) Int. Cl. G09G 5/02

(52) U.S. Cl. CPC G09G 5/02
USPC 345/589

(57) ABSTRACT

An image processing apparatus includes a first display controller configured to display a first image, a touch area detector configured to detect a touched area of the displayed first image, a first processor configured to change a tone of the touched area of the first image, a storage configured to store touched areas detected by the touch area detector, a second display controller configured to display a second image instead of the first image, and a second processor configured to change tones of the touched areas of the second image which are stored in the storage.

### CROSS-REFERENCE TO RELATED APPLICATIONS

This is a Divisional of U.S. application Ser. No. 13/192,984, filed Jul. 28, 2011, which is based upon and claims the benefit of priority from prior Japanese Patent Application No. 2010-172202, filed Jul. 30, 2010, the entire contents of both of which are incorporated herein by reference.

### BACKGROUND OF THE INVENTION

1. Field of the Invention

The present invention relates to an image processing apparatus, an image processing system, and an image processing method that change a tone of an image.

2. Description of the Related Art

An image processing method that easily creates an artwork image that artificially reproduces features observed in paintings produced by painters from an original image in non-painting tone such as a snapshot has been known.

According to this image processing method, a painting image drawn by an actual painter is input along with an original image to be processed and color information and information about a touch of the brush are analyzed from the painting image. Then, based on the analyzed information, an artwork image is generated by imitating colors of the original image and arranging the touch of the brush (see, for example, Jpn. Pat. Appln. KOKAI Publication No. 2004-213598).

Thus, by using a snapshot taken by a digital camera as the original image, the snapshot can be converted into an artwork image imitating a painting drawn by a specific painter.

However, according to the conventional technology, an apparatus automatically completes, based on the analyzed information, an artwork by imitating colors of the original image and arranging the touch of the brush. Thus, a user cannot join in the creation of an artwork image and can only view the completed artwork image.

Therefore, user's interest in image processing cannot be increased and a user's desire to draw a painting cannot be satisfied, proving unsatisfactory in arousing user's interest.

### BRIEF SUMMARY OF THE INVENTION

It is an object of the invention to provide an image processing apparatus, an image processing system, an image processing method, and a storage medium capable of increasing user's interest in processing an image or satisfying a user's desire to draw an artwork by changing a tone of an original image accompanied by user's involvement.

According to an embodiment of the present invention, an image processing apparatus comprises:

a first display controller configured to display a first image;

a touch area detector configured to detect a touched area of the first image displayed by the first display controller;

a first processor configured to change a tone of the touched area of the first image;

a storage configured to store the touched area detected by the touch area detector;

a second display controller configured to display a second image instead of the first image; and

a second processor configured to change a tone of the touched area of the second image which is stored in the storage.

According to another embodiment of the present invention, an image processing system comprises an image processing apparatus and an imaging apparatus connected to the image processing apparatus via a network, wherein the imaging apparatus comprises:

a transmitter configured to transmit images, the images comprising a first image and a second image, and wherein the image processing apparatus comprises:

a receiver configured to receive the images transmitted from the transmitter;

a first display controller configured to display the first image;

a touch area detector configured to detect a touched area of the first image displayed by the first display controller;

a first processor configured to change a tone of the touched area of the first image;

a storage configured to store the touched area detected by the touch area detector;

a second display controller configured to display the second image instead of the first image; and

a second processor configured to change the tone of the touched area of the second image which is stored in the storage.

According to another embodiment of the present invention, an image processing method comprises:

displaying a first image;

detecting a touched area of the displayed first image;

changing a tone of the touched area of the first image;

storing the detected touched area;

displaying a second image instead of the first image; and

changing a tone of the touched area of the second image which is stored.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a circuit configuration and a system configuration of an apparatus according to an embodiment of the present invention.

FIG. 2 shows a memory configuration of a RAM.

FIG. 3 is a flowchart showing a main routine.

FIG. 4 is a flowchart showing a processing procedure for display processing.

FIG. 5 is a flowchart showing the processing procedure for switch processing.

FIG. 6 is a flowchart showing the processing procedure for capture switch processing.

FIG. 7 is a flowchart showing the processing procedure for touch processing.

FIG. 8 is a flowchart showing the processing procedure for conversion processing.

FIG. 9 is a flowchart showing the processing procedure for complete switch processing.

FIG. 10 is a flowchart showing the processing procedure for total conversion processing.

FIG. 11A is a diagram showing an example of an image to be processed.

FIG. 11B is a diagram showing an artwork image corresponding to FIG. 11A.

FIG. 12A is a diagram showing another example of the image to be processed.

FIG. 12B is a diagram showing the artwork image corresponding to FIG. 12A.

FIG. 13 is a circuit configuration diagram of the apparatus according to another embodiment of the present invention.

FIG. 14 is an example of a shape of a touch area.

FIG. 15A illustrates an example of an image to be processed.

FIG. 15B illustrates how the image of FIG. 15A is processed with the touch.

FIG. 15C illustrates how the image of FIG. 15B is processed with the touch.

FIG. 16 is an example how a touch area is generated based on detection of a moving speed and strength of a finger when a user touches a screen with the finger.

FIG. 17 is a figure illustrating an external view of an image processing apparatus 200.

### DETAILED DESCRIPTION OF THE INVENTION

An embodiment of an image processing apparatus, an image processing system, an image processing method, and a storage medium according to the present invention will now be described with reference to the accompanying drawings.

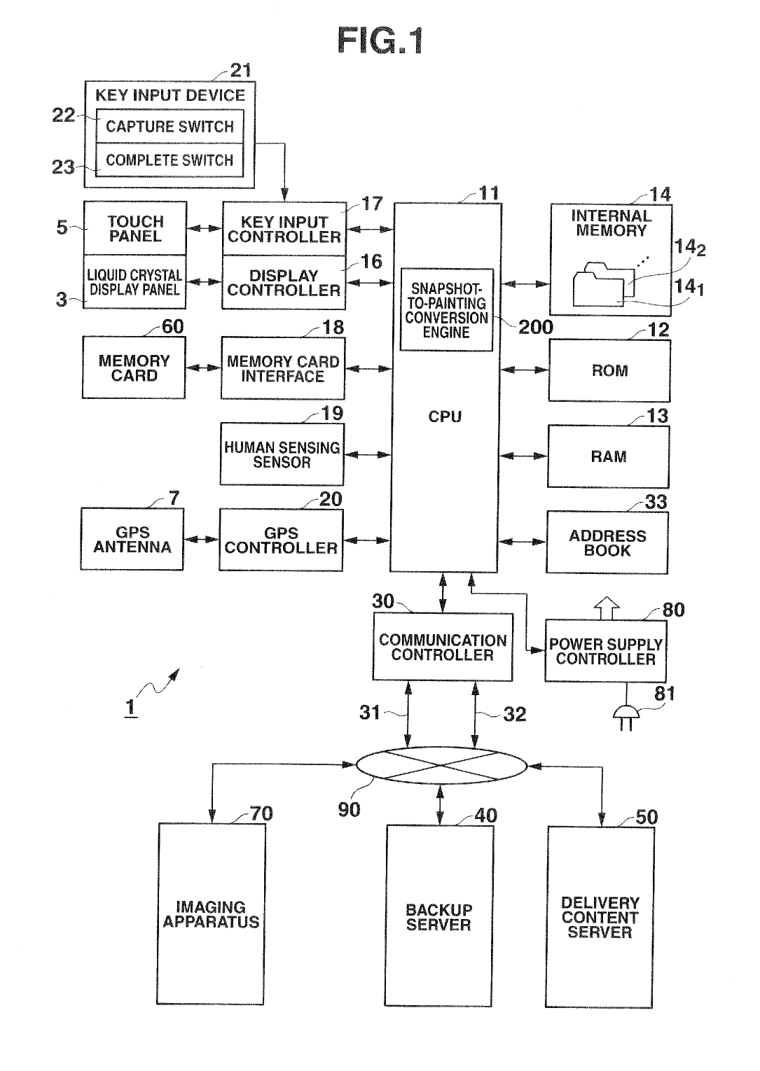

FIG. 1 is a block diagram showing an electric configuration of an image processing apparatus 1 according to the present embodiment and an image processing system including the image processing apparatus 1. The image processing apparatus 1 includes a central processing unit (CPU) 11, a read-only memory (ROM) 12 connected to the CPU 11, a random access memory (RAM) 13, and an internal memory 14 and a program causing the CPU 11 to perform operations shown in flowcharts described later is stored in the ROM 12.

The CPU 11 includes a snapshot-to-painting conversion engine 200 that converts a non-artwork image such as a snapshot into an artwork image. Snapshot-to-painting conversion processing changes a tone of an original image such that an original image (captured image) stored in the RAM 13 and to be processed is converted into an artwork image having features of the original image, that is, an artwork image in which a specific effect is produced and the artwork image is displayed in a liquid crystal display panel 3. The non-artwork image from which to convert is not limited to snapshots and may be an image created by CG or an image obtained by scanning a hand-written picture.

For conversion into an artwork image, the type of a target painting, that is, features (painting tone) of the converted artwork image can be selected. In the present embodiment, selectable painting tones include 12 styles of artwork: oil painting, thick oil painting, gothic oil painting, fauvist oil paining, water color painting, gouache painting, pastel painting, color pencil sketch, pointillism, silkscreen, drawing, and air brush, which are drawn/painted by a real artist. However, painting tones are not limited to the above examples and conversions having painters' features added such as a Van Gogh tone, Monet tone, and Picasso tone may be made selectable. Alternatively, an algorithm of other painting tones may be provided by a memory card 60 described later. It is assumed in the description of the present embodiment below that the oil painting tone is pre-selected.

The internal memory 14 is a large-capacity nonvolatile memory of a hard disk or flash memory in which folders 14₁, 14₂, . . . are formed by processing described later so that artwork images, which are painting tone converted images, can be saved in each of the folders 14₁, 14₂, . . . .

A display controller 16 causes the liquid crystal display panel 3 to display an image or various menus by driving the liquid crystal display panel 3 based on display image data supplied from the CPU 11.

A key input controller 17 inputs an operation signal of a touch panel 5 or an operation signal of a key input device 21 based on control of the CPU 11. In the present embodiment, the key input device 21 includes at least a capture switch 22 and a complete switch 23 and in addition, a power switch (not shown), mode changeover switch (not shown) and the like. The capture switch 22 and the complete switch 23 are normally open switches that maintain an off state by being projected and are turned on only when pressed by the user.

A memory card interface 18 is an input/output interface that controls input/output of data between a variety of the memory cards 60 detachably inserted into a memory card slot and the CPU 11. A GPS controller 20 acquires position information based on information received by a GPS antenna 7. In this manner, the current position of the image processing apparatus 1 can be known.

A human sensing sensor 19 is connected to the CPU 11 and is used to detect whether any human being is in the vicinity thereof. Thus, if a state in which no human being is in the vicinity thereof lasts for a predetermined time or longer, power is automatically turned off to save energy (auto power-off).

A communication controller 30 exercises communication control including transmission and reception of images or mail via a telephone line 31 or a wireless LAN 32. An address book 33 is used for mail transmission/reception and is actually provided inside the internal memory 14.

A backup server 40 is connected via a network 90 and backs up data stored in the internal memory 14 automatically or based on manual instructions. A content server 50 has a large number of pieces of content or images and can deliver data to the image processing apparatus 1 via the network 90.

An imaging apparatus 70 is a so-called digital camera and includes an image sensor, an imaging controller to control the image sensor, and an image transmission unit. The imaging controller drives the image sensor and captures a color image of a subject at a predetermined frame rate. The transmission unit transmits a live view image including the captured image to the outside. The imaging apparatus 70 is connected to the communication controller 30 of the image processing apparatus 1 through the telephone line 31 or the wireless LAN 32 via the network 90. Thus, the CPU 11 of the image processing apparatus 1 can sequentially capture the live view image picked up by the imaging apparatus 70 and transmitted by the transmission unit.

At this point, since the imaging apparatus 70 is arranged at a remote location that is different from the location of the image processing apparatus 1 owned by the user, the user can view scenes of the remote location through the liquid crystal display panel 3 of the image processing apparatus 1 or select scenes of the remote location as images to be converted.

A power supply controller 80 receives an AC power supply via a power supply plug 31 and converts AC into DC before supplying power to each unit. The power supply controller 80 also controls the auto power-off.

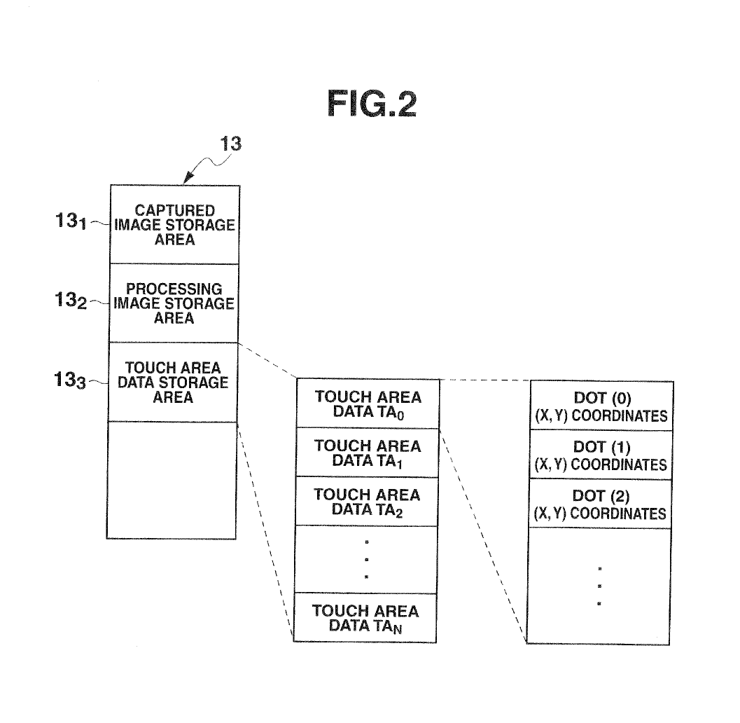

FIG. 2 shows a memory configuration of the RAM 13. The RAM 13 is a work memory in which the CPU 11 temporarily stores various kinds of data when necessary and includes a captured image storage area 13₁, a processing image storage area 13₂, and a touch area data storage area 13₃.

Live view images transmitted, as described above, at a predetermined frame rate from the imaging apparatus 70 are sequentially stored in the captured image storage area 13₁ while being updated. Then, the liquid crystal display panel 3 is driven based on image data captured by the display controller 16 and stored in the captured image storage area 13₁ under the control of the CPU 11 until the capture switch 22 is operated. Accordingly, the live view image being picked up by the imaging apparatus 70 is displayed in the liquid crystal display panel 3.

An image displayed on the liquid crystal display panel 3 when the capture switch 22 is operated is stored in the processing image storage area 13₂ as a processing image (capture image). At this point, the display controller 16 switches the read source of images from the captured image storage area 13₁ to the processing image storage area 13₂. Thus, after the capture switch 22 is operated, the processing image (capture image) continues to be displayed on the liquid crystal display panel 3.

The image stored in the processing image storage area 13₂ is converted into an oil painting image by conversion processing described later and the display controller 16 reads the image in the processing image storage area 13₂ in predetermined timing (at a predetermined frame rate) to display the image on the liquid crystal display panel 3. Thus, after the capture switch 22 is operated, instead of the live view image, a converted image being gradually converted into an oil painting image is displayed.

The touch area data storage area 13₃ stores data “touch area data TA₀”, “touch area data TA₁”, “touch area data TA₂”, . . . , “touch area data TA_{N}” showing touch areas that are areas from positions where a touch is detected by the touch panel 5 to positions the touch is no longer detected. That is, in the present embodiment, an area from a position where a touch is detected by the touch panel 5 to a position where the touch is no longer is detected is defined as a unit of the touch area and data showing the touch area in this unit is stored.

Content of data “touch area data TA₀”, “touch area data TA₁”, “touch area data TA₂”, . . . , “touch area data TA_{N}” showing each touch area includes, as shown on the right end portion of FIG. 2, x and y coordinates of each dot belonging to the area in an image like “x and y coordinates of dot 0”, “x and y coordinates of dot 1”, “x and y coordinates of dot 2”, . . That is, if “touch area data TA₀” includes dot 0 to dot n, coordinates of these dot 0 to dot n in an image are stored as data of “touch area data TA₀”.

Next, operations of the present embodiment according to the above configuration will be described.

(Live View Image Display)

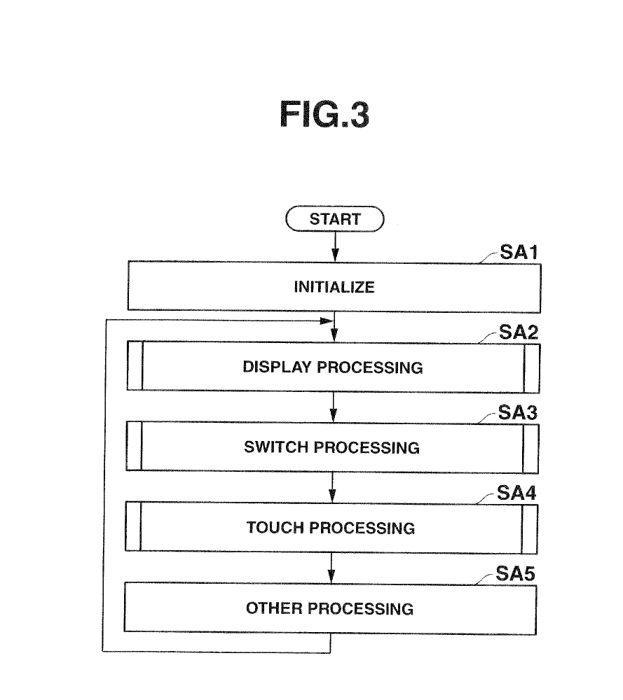

When the power supply switch is turned on, the CPU 11 starts control and processing of each unit according to a program stored in the ROM 12. FIG. 3 is a flowchart showing a processing procedure of the CPU 11. First, the CPU 11 performs initialization processing to reset a flag used in the flow described later and also to clear the captured image storage area 13₁, the processing image storage area 13₂, and the touch area data storage area 13₃ of the RAM 13 shown in FIG. 2 (step SA1). Subsequently, the CPU 11 sequentially repeats display processing (step SA2), switch processing (step SA3), touch processing (step SA4), and other processing (step SA5) until the power supply switch is turned off.

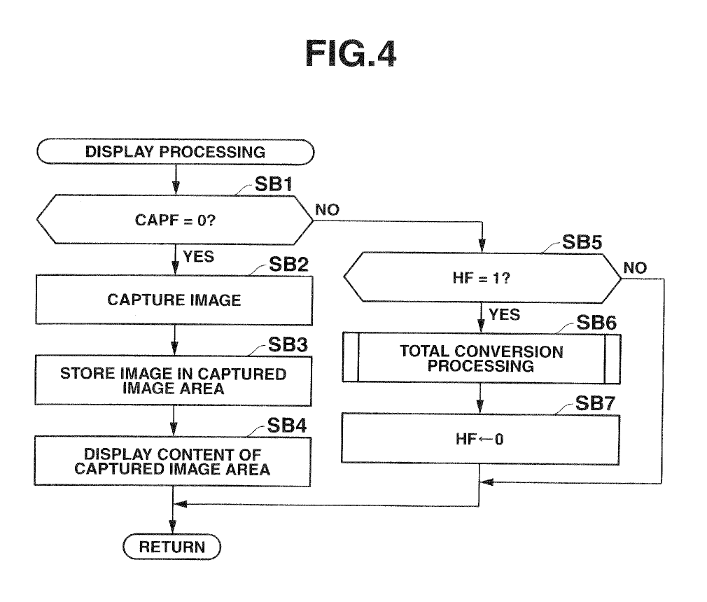

FIG. 4 is a flowchart showing details of the display processing (step SA2). The CPU 11 determines whether a capture flag CAPF is a reset (=0) (step SB1). The capture flag CAPF is a flag that is reset (=0) by the initialization processing and set (=1) by the capture switch 22 being pressed. Thus, CAPF=0 when the display processing is started and thus, the CPU 11 proceeds from step SB1 to step SB2.

Then, the CPU 11 captures a live view image transmitted via the network 90 and the telephone line 31 or the wireless LAN 32 from the imaging apparatus 70 (step SB2) and stores the live view image in the captured image storage area 13₁ (step SB3). Further, the CPU 11 controls the display controller 16 to cause the liquid crystal display panel 3 to display content of the live view image stored in the captured image storage area 13₁ (step SB4).

Thus, live view images picked up by the imaging apparatus 70 and transmitted at a predetermined frame rate are displayed on the liquid crystal display panel 3 after the power supply switch is turned on until the capture switch 22 is operated. Therefore, the user can enjoy viewing live view images displayed on the liquid crystal display panel 3. Processing in steps SB5 to SB7 performed when CAPF=1 will be described later.

(Decision of the Image to be Processed)

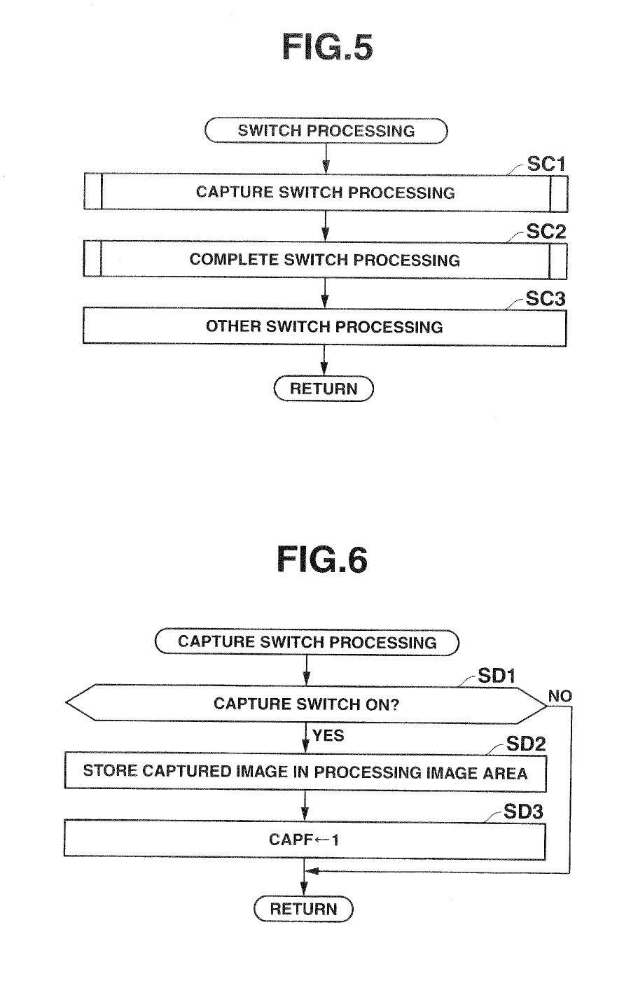

FIG. 5 is a flowchart showing the processing procedure for the switch processing (step SA3). The switch processing includes capture switch processing (step SC1), complete switch processing (step SC2), and other switch processing (step SC3).

FIG. 6 is a flowchart showing the processing procedure for the capture switch processing (step SC1). The CPU 11 determines whether the capture switch 22 is pressed (step SD1). If the capture switch 22 is determined to be pressed, the CPU 11 stores the captured image captured at this point and displayed on the liquid crystal display panel 3 in the processing image storage area 13₂. Then, as described above, the display controller 16 switches the read source of images from the captured image storage area 13₁ to the processing image storage area 13₂. Thus, after the capture switch 22 is operated, the processing image (capture image) continues to be displayed on the liquid crystal display panel 3. Thereafter, the CPU 11 sets the capture flag CAPF (=1) (step SD3) to indicate that the capture switch 22 has been pressed before returning.

Thus, the user viewing the live view images in the liquid crystal display panel 3 presses the capture switch 22 when the image whose painting tone should be converted is displayed on the liquid crystal display panel 3. Accordingly, the processing target image whose tone should be changed is decided, the image is stored in the processing image storage area 13₂, and the liquid crystal display panel 3 is maintained in a state in which the image is displayed.

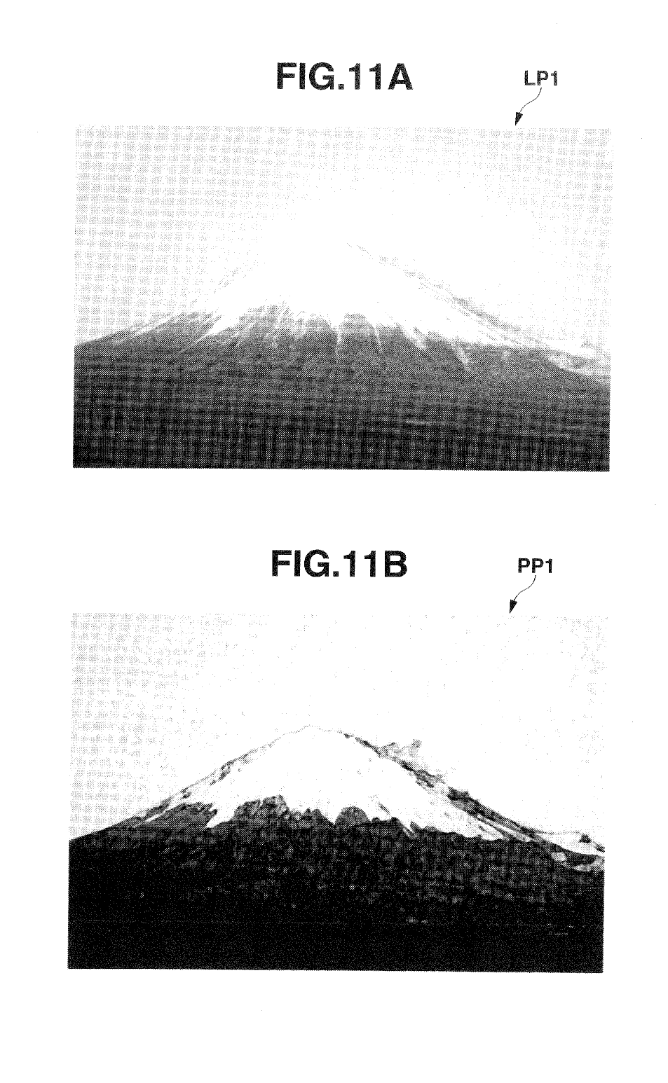

If, for example, as shown in FIG. 11A, the user operates the capture switch 22 while a live view image of Mt. Fuji is displayed to decide the image as an original image, the live view image is saved in the processing image storage area 13₂ as a processing image LP1 and the liquid crystal display panel 3 is maintained in a state in which the processing image LP1 is displayed.

Therefore, while viewing the liquid crystal display panel 3 in which live view images are displayed, the user can select a desired image as an original image, that is, a material for an image to be imitatively drawn by operating the capture switch 22 at any time.

The complete switch processing (step SC2) in the flowchart in FIG. 5 will be described later.

(Image Conversion)

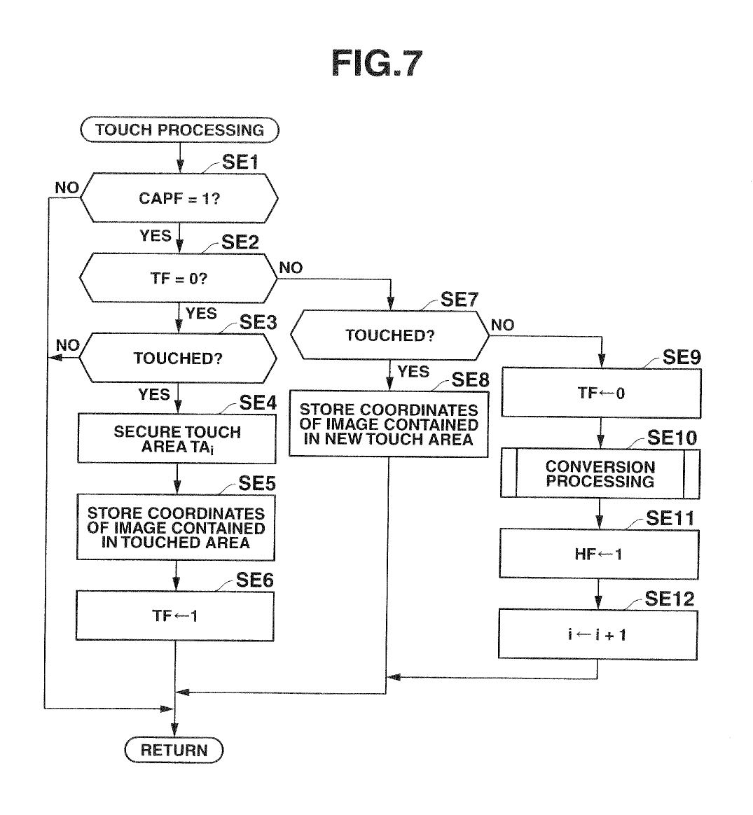

FIG. 7 is a flowchart showing the processing procedure for the touch processing (step SA4). First, the CPU 11 determines whether the capture flag CAPF is set (=1) (step SE1). If CAPF=0, the CPU 11 returns to the main flow without performing the following processing because the image to be processed is not yet decided (not yet captured).

If, however, CAPF=1, as described in the flowchart in FIG. 6, the capture switch 22 is pressed, a captured image is saved in the processing image storage area 13₂, and the processing image LP1 is decided. Thus, the CPU 11 proceeds from step SE1 to step SE2 to determine whether a touch flag TF=0.

The touch flag TF is set (=1) in step SE6 described later on condition that the touch is detected by the touch panel 5 through a user's finger while the processing image storage area 13₂ is displayed on the liquid crystal display panel 3. The touch flag TF is reset (=0) in step SE9 described later on condition that the touch is no longer detected.

Thus, TF=0 while the user is not touching the processing image LP1 on the screen displayed on the liquid crystal display panel 3. If TF=0 and the user is not touching the processing image LP1 on the screen, the CPU 11 proceeds from step SE2 to step SE3 to determine whether the user touches the processing image LP1. If the user is determined to touch, the CPU 11 secures touch area data TAᵢ, which is an i-th touch area beginning with the initial value of “0”, in the touch area data storage area 13₃ shown in FIG. 2 (step SE4). Subsequently, the CPU 11 stores coordinates of pixels contained in the area of the touched processing image LP1 in the touch area data TAᵢ secured in step SE4 (step SE5). Thereafter, the CPU 11 sets (=1) the touch flag TF (step SE6) before returning.

Therefore, when one touch is started by assuming that the unit of one touch is from the start of a touch to the end of the touch, the start of the touch is indicated by the touch flag TF being set.

If TF changes to 1, the determination in step SE2 becomes NO when the processing according to the flowchart is performed again. Thus, the CPU 11 proceeds from step SE2 to step SE7 to determine whether the processing image LP1 is still being touched, that is, the touch still continues. If the touch continues, the CPU 11 stores coordinates of pixels contained in new touch areas after being stored in step SE5 in the touch area data TAᵢ secured in step SE4 (step SE8).

If the user moves the touched finger away from the processing image LP1 on the screen, the determination in step SE7 becomes NO when the processing according to the flow is performed again and the CPU 11 proceeds from step SE7 to step SE9. Therefore, the data “touch area data TA₀” indicating one touch area that is an area from the start of a touch detected by the touch panel 5 to the end of the touch is stored in the touch area data storage area 13₃ shown in FIG. 2.

Then, in step SE9 subsequent to step SE7, the CPU 11 resets (=0) the touch flag TF because the one touch has ended. Thereafter, the CPU 11 performs conversion processing described later (step SE10). Thus, the conversion processing will be performed each time one touch ends by assuming that the unit of one touch is from the start of a touch to the end of the touch.

Therefore, the painting tone in an area touched of the processing image LP1 is changed by the conversion processing each time one touch ends so that the user can appreciate the sense of painting on canvas. Moreover, the user paints by using the processing image LP1 as a rough sketch so that a user who is not good at painting can be made to think of being able to paint well.

The detected touch area is an area that assumes from the start of a touch to the end of the touch as one touch and thus, the area closely resembles a touch operation of the brush so that features of user's touch of the brush can be reflected in touch data.

Subsequently, the CPU 11 sets a conversion flag HF indicating that conversion processing is being performed (step SE11) and increments the value of i (step SE12) before returning.

Therefore, after CAPF changes to 1 and the processing image LP1 is decided, the touch processing shown in the flowchart of FIG. 7 is performed each time the user touches the processing image LP1 on the screen and data indicating the touch area of the processing image LP1 on the screen by the user is stored in the touch area data storage area 13₃ like “touch area data TA₀”, “touch area data TA₁”, “touch area data TA₂”, . . . , “touch area data TAᵢ”. The data indicating these touch areas becomes, as described above, x and y coordinates in the processing image LP1 of each dot (pixel) belonging to the relevant area.

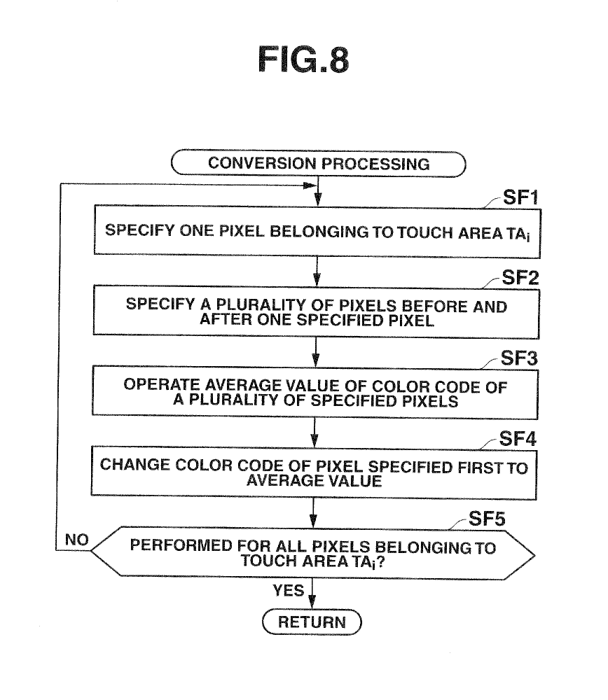

FIG. 8 is a flowchart showing the processing procedure for the conversion processing (step SE10) performed each time one touch ends. First, the CPU 11 specifies, based on a group of coordinates of pixels stored in touch area data TAᵢ, which is data indicating the touch area stored in step SE5 or step SE8, one pixel belonging to the touch area of the processing image LP1 (step SF1). Next, the CPU 11 specifies a plurality of pixels before and after the specified pixel (step SF2).

The CPU 11 also operates an average value of color codes of the one pixel specified in step SF1 and the plurality of pixels specified in step SF2 (step SF3). Next, the CPU 11 changes the color code of the one pixel specified first (the one pixel specified in step SF1) to the average value operated in step SF3 (step SF4). Further, the CPU 11 determines whether the processing to change the color code has been performed on all pixels belonging to the touch area TAᵢ (step SF5). Then, the CPU 11 repeats the processing starting with step SF1 until the processing on all pixels belonging to the touch area TAᵢ is completed.

Therefore, the color codes of all pixels belonging to the touch area TAᵢ are changed to the average value of the plurality of pixels before and after the one pixel whose color code has been changed before the determination in step SF5 becomes YES. Consequently, after each one touch of the processing image LP1 on the screen by the user, the color of the area of the one touch is changed to a different color from the original color of the processing image LP1. Accordingly, conversion to an artwork image can be made while being accompanied by user involvement in which one touch of the processing image LP1 on the screen is repeated. As a result, user's interest in painting tone conversion can be increased or a user's desire to paint can be satisfied.

Moreover, if one touch as a touch operation of the brush is continued by using the processing image LP1 as a rough sketch, the processing image LP1 shown in FIG. 11A changes to an artwork image PP1 shown in FIG. 11B to complete artwork image PP1. Accordingly, even a user who is not good at painting can paint, though imitatively, a desired picture without difficulty.

The conversion processing shown in the flowchart of FIG. 8 is performed in the present embodiment, but the conversion processing is not limited to the above example and any algorithm such as another painting tone conversion algorithm may be used. For example, all the pixels in the touch area may not be changed into the color code of the average value. In the pixels in the touch area, farther a pixel is located from the initially specified pixel, the lighter the color thereof may be. Alternatively, a color of pixels on a periphery of the touch area may be detected. As a pixel gets closer to the periphery, the color of the pixel may become closer to the color of the periphery than the color of the initially specified pixel. Further, when the image to be processed LP1 is converted into oil painting tone, the area in the touch area can be converted into oil painting tone, and when the image to be processed LP1 is converted into water color painting tone, the area in the touch area can be converted into water color painting tone.

(Completion of the Artwork Image)

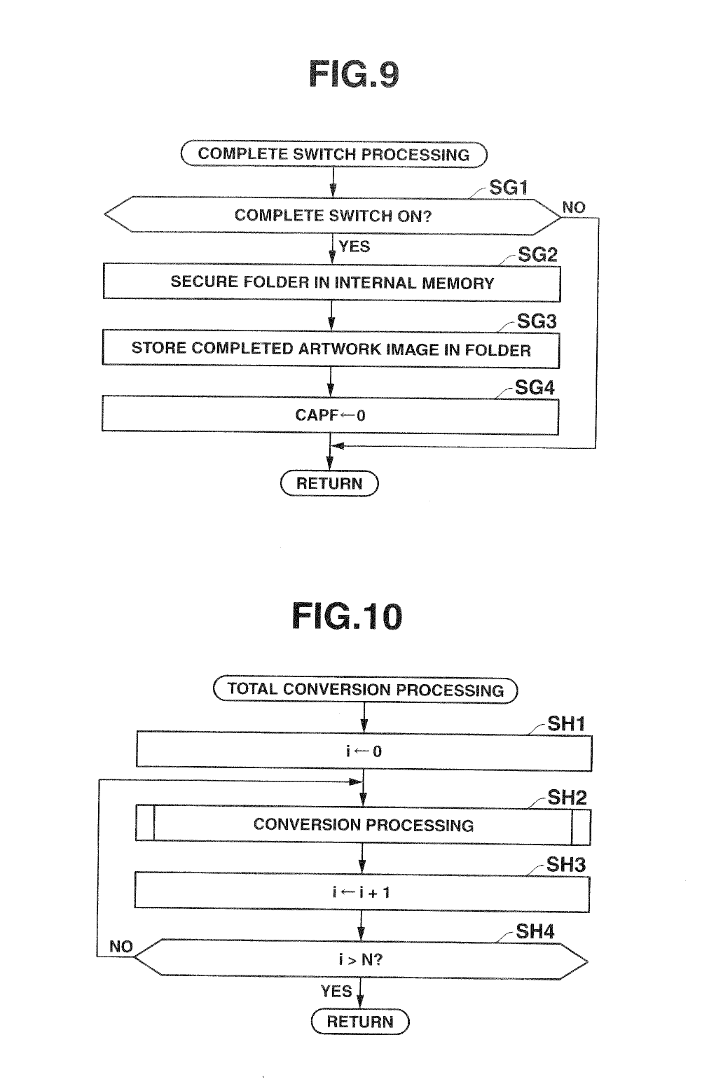

FIG. 9 is a flowchart showing the processing procedure for the complete switch processing in step SC2 in the flowchart of FIG. 5. That is, when the user confirms that the conversion is completed by viewing artwork image PP1 displayed on the screen of the liquid crystal display panel 3, the user presses the complete switch 23. Then, the determination in step SG1 in the flowchart of FIG. 9 becomes YES. Therefore, the CPU 11 proceeds from step SG1 to step SG2 to secure the new folder 14₁ in the internal memory 14. Then, the CPU 11 stores the completed artwork image PP1 in the secured folder 14₁.

Therefore, the user can freely decide the completion of artwork image PP1 by operating the complete switch 23 at any time point.

The user can also view artwork image PP1 stored in the folder 14₁ of the internal memory 14 at any time by causing the CPU 11 to read artwork image PP1 from the folder 14₁ and causing the liquid crystal display panel 3 to display artwork image PP1 at a later date. Then, the CPU 11 resets the capture flag CAPF (=0) (step SG4) before returning.

(Total Conversion of Live View Images)

After the capture flag CAPF is set to 0 in step SG4 as described above, the determination in step SB1 in the flowchart of FIG. 4 becomes YES. Thus, the live view image transmitted from the imaging apparatus 70 begins to be captured again (step SB2), is stored in the captured image storage area 13₁ (step SB3), and is displayed on the liquid crystal display panel 3 (step SB4). That is, the display of the live view image is restarted. Therefore, even if, for example, the imaging apparatus 70 images Mt. Fuji in the same angle of view, Mt. Fuji composed of a different scene from Mt. Fuji in the processing image LP1 may be displayed due to changes of clouds and light with the passage of time.

For example, the scene of Mt. Fuji shown in

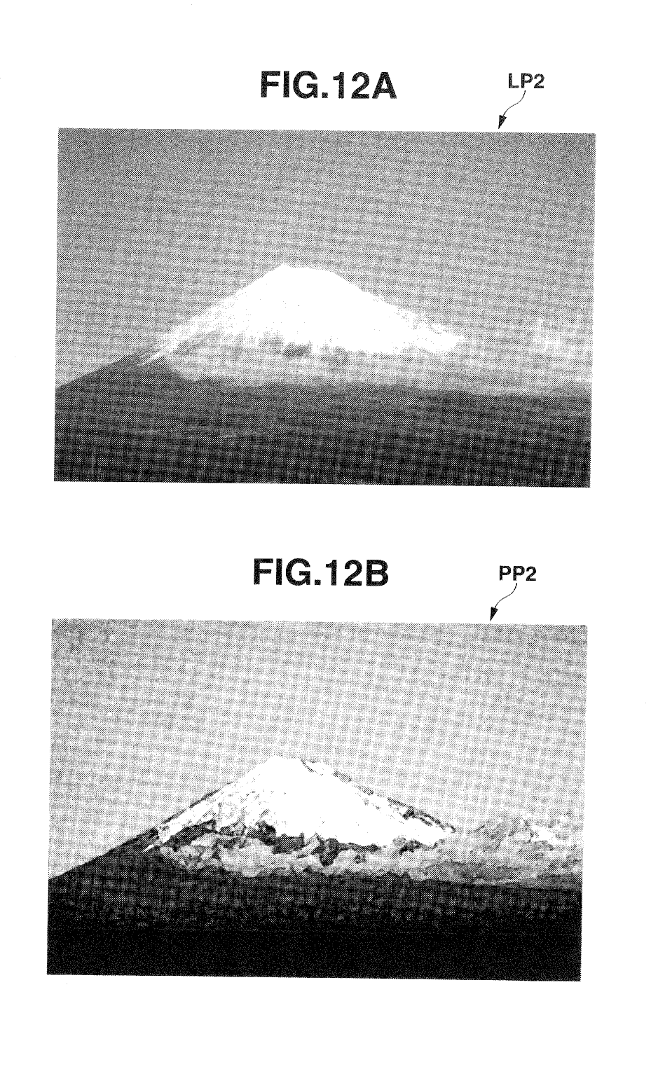

FIG. 11A may change to the scene of Mt. Fuji shown in FIG. 12A. If the user also wants to convert the scene of Mt. Fuji shown in FIG. 12A into an artwork image, the user presses the capture switch 22 again when the scene in FIG. 12A is displayed on the liquid crystal display panel 3.

Then, the determination in step SD1 in the flowchart of FIG. 6 becomes YES and the CPU 11 stores the captured image captured at this point and displayed on the liquid crystal display panel 3 in the processing image storage area 13₂ (step SD2). Then, as described above, the display controller 16 switches the read source of images from the captured image storage area 13₁ to the processing image storage area 13₂. Thus, after the capture switch 22 is operated, the image shown in FIG. 12A continues to be displayed on the liquid crystal display panel 3 as a processing image LP2. In processing in step SD3 subsequent to step SD2, the capture flag CAPF is set (=1).

On the other hand, if CAPF is set to 1 in this manner, the determination in step SB1 in the flowchart of FIG. 4 becomes NO. Thus, the CPU 11 proceeds from step SB1 to step SB5 to determine whether the conversion flag HF is 1. In this case, the conversion flag HF is set when the first conversion described above is made, that is, in step SE11 in the flowchart of FIG. 7 when artwork image PP1 shown in FIG. 11B is created and HF=1. Thus, the determination in step SB5 in the flowchart of FIG. 4 becomes YES.

Therefore, the CPU 11 proceeds from step SB1 to step SB5 to determine whether the conversion flag HF is 1. The conversion flag HF is set in step SE11 in the flowchart of FIG. 7 when artwork image PP1 is generated last time and HF=1. Thus, the CPU 11 proceeds from step SB5 to step SB6 to perform total conversion processing and then, resets (=0) HF (step SB7) before returning.

FIG. 10 is a flowchart showing the processing procedure for the total conversion processing (step SB6). First, the CPU 11 sets the initial value “0” to a variable i (step SH1). Then, the CPU 11 performs conversion processing based on a group of coordinates stored in “touch area data TA_{T}” corresponding to i (step SH2).

The conversion processing is performed according to the processing procedure shown in the flowchart of

FIG. 8. First, the CPU 11 specifies, based on a group of coordinates of pixels stored in the touch area data TAᵢ, one pixel belonging to the touch area of the processing image LP2 (step SF1). Next, the CPU 11 specifies a plurality of pixels before and after the specified pixel (step SF2).

The CPU 11 also operates an average value of color codes of the one pixel specified in step SF1 and the plurality of pixels specified in step SF2 (step SF3). Next, the CPU 11 changes the color code of the one pixel specified first (the one pixel specified in step SF1) to the average value operated in step SF3 (step SF4). Further, the CPU 11 determines whether the processing to change the color code has been performed on all pixels belonging to the touch area TAᵢ (step SF5). Then, the CPU 11 repeats the processing starting with step SF1 until the processing on all pixels belonging to the touch area TAᵢ is completed.

Therefore, the color codes of all pixels belonging to the touch area TAᵢ specified by the value of i are changed to the average value of the plurality of pixels before and after the one pixel whose color code has been changed before the determination in step SF5 becomes YES. Consequently, the color of the processing image LP2 is changed to a different color from the original color by touch data when the processing image LP1 is created without one touch, which is an imitative painting operation on the processing image LP2 on the screen, by the user. Thus, in this case, conversion to an artwork image can be made by using the last touch data without the need to perform an operation of repeating one touch on the processing image LP2 on the screen.

Then, after the conversion processing in step SH2 is performed, the CPU 11 increments the value of i (step SH3) and determines whether i>N (step SH4). The CPU 11 repeats the processing of steps SH2 to SH4 before the relation i>N holds. Therefore, a painting tone conversion can be made by using touch data stored in each of the touch area Tao to touch area TA_{N} used in the last artwork image PP1 and stored in the touch area data storage area 13₃.

In the case of the above modification, a color of pixels on a periphery of the touch area is detected, and as a pixel gets closer to the periphery, the color of the pixel becomes closer to the color of the periphery than the color of the initially specified pixel. In this case of the modification, the color of the periphery changes, and accordingly, the color in the touch area also changes.

Then, when the relation i>N holds and the painting tone conversion is completed by using all touch data stored in the touch area TA₀ to touch area TA_{N} stored in the touch area data storage area 13₃, the processing image LP2 shown in FIG. 12A changes to an artwork image PP2 shown in FIG. 12B. If the user who has confirmed artwork image PP2 presses the complete switch 23, the complete switch processing is performed according to the flowchart shown in FIG. 9 described above. Accordingly, the new folder 14₂ is secured in the internal memory 14 and artwork image PP2 is saved in the new folder 14₂.

Incidentally, while a professional painter creates a large number of paintings, the style of the painter and common features based on the style generally appear in every painting. For a nonprofessional, on the other hand, the style has not yet been established and features of every painting vary.

Although the image serving as a base is different for artwork image PP2 newly saved in the new folder 14₂ (the processing image LP1 and the processing image LP2), artwork image PP2 is an image in which the touch when the artwork image PP1 is created by the user is reflected.

Thus, artwork image PP1 saved in the last folder 14₁ and artwork image PP2 saved in the current folder 14₂ are in common in that the touch when artwork image PP1 is created by the user is reflected in these images. Therefore, even a nonprofessional can express, like a professional painter, the style and features based on the style common to artwork images PP1 and PP2 as works.

In the present embodiment, a live view image transmitted from the imaging apparatus 70 is acquired and set as a processing image, which is an image whose painting tone should be converted. However, the processing image is not limited to the above example and may be any image such as an image stored in the internal memory 14 in advance or an image downloaded from the delivery content server 50. It should be noted that touch operation may be performed with anything such as a finger, a pen, or a mouse.

### Other Embodiments

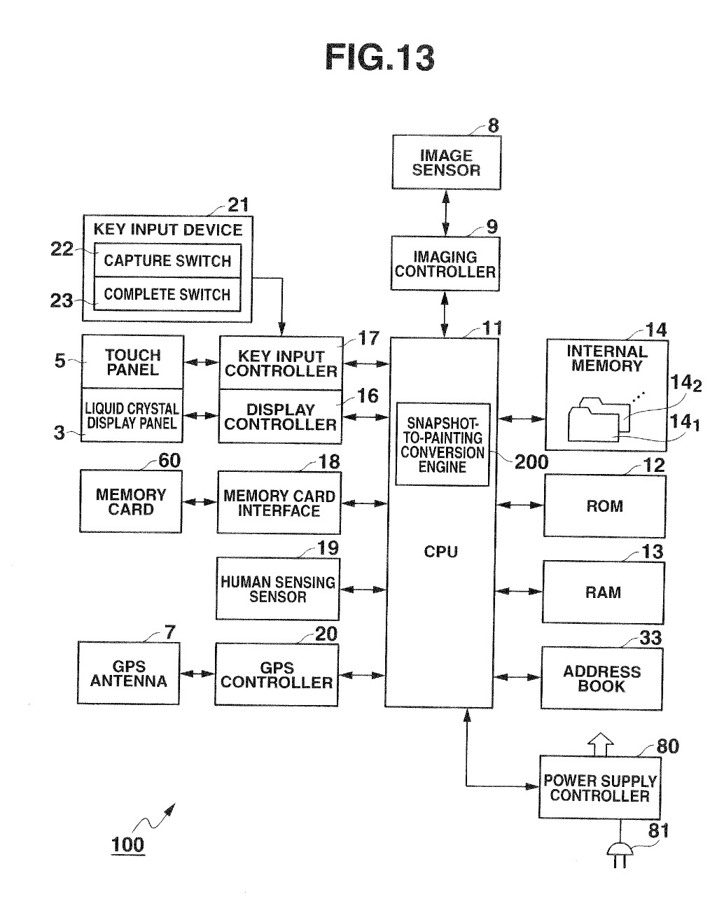

FIG. 13 is a block diagram showing an electric configuration of an image processing apparatus 100 according to the second embodiment of the present invention. In the second embodiment, the communication controller 30 and a network connected to the communication controller 30 which are provided in the first embodiment are not provided and instead, an image sensor 8 is connected to the CPU 11 via an imaging controller 9. The imaging controller 9 controls to capture a subject image by driving the image sensor 8 under the control of the CPU 11.

The captured subject image is displayed, like in the first embodiment, in the liquid crystal display panel 3 by the display controller 16. The CPU 11 performs the processing shown in the flowcharts in

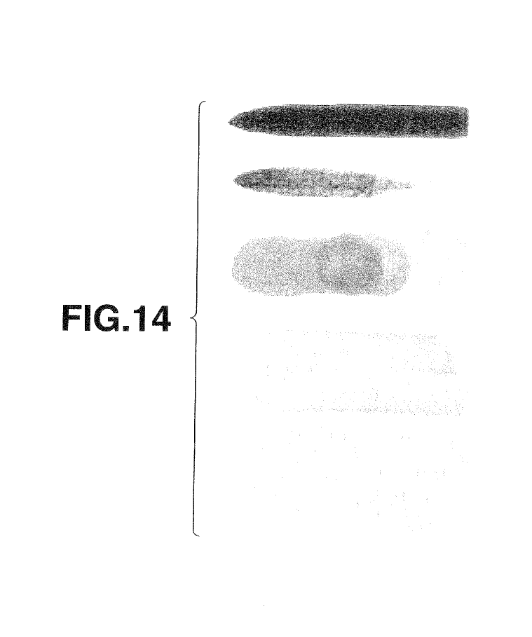

FIGS. 3 to 10 described above. Therefore, according to the second embodiment, live view images can be displayed by the image processing apparatus 100 alone, a desired live view image can be captured, the painting image conversion of the captured live view image can be made in accordance with the touch, and further live view images can all be converted without connecting to a network. FIG. 14 illustrates an example of a shape of a touch area. The area touched with a finger may be simply adopted as a touch area, but when a technique of photo retouch software is applied, various brush touches can be generated as shown in FIG. 14 from the actually touched area.

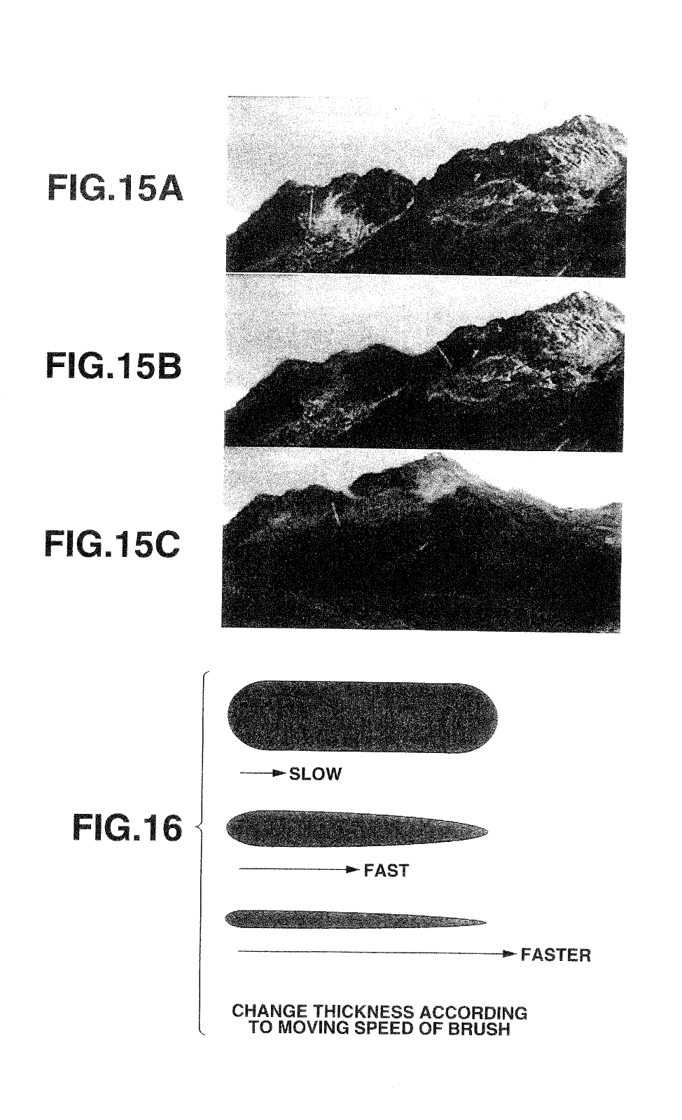

FIG. 15A is an example of an image to be processed. FIGS. 15B and 15C show how the image is processes based on the touch.

FIG. 16 is an example where a touch area is generated by detecting a moving speed and strength of a finger when a user touches a screen with the finger. When a finger is moved slowly, a thick touch area can be obtained. As the movement becomes faster, the end portion becomes thinner.

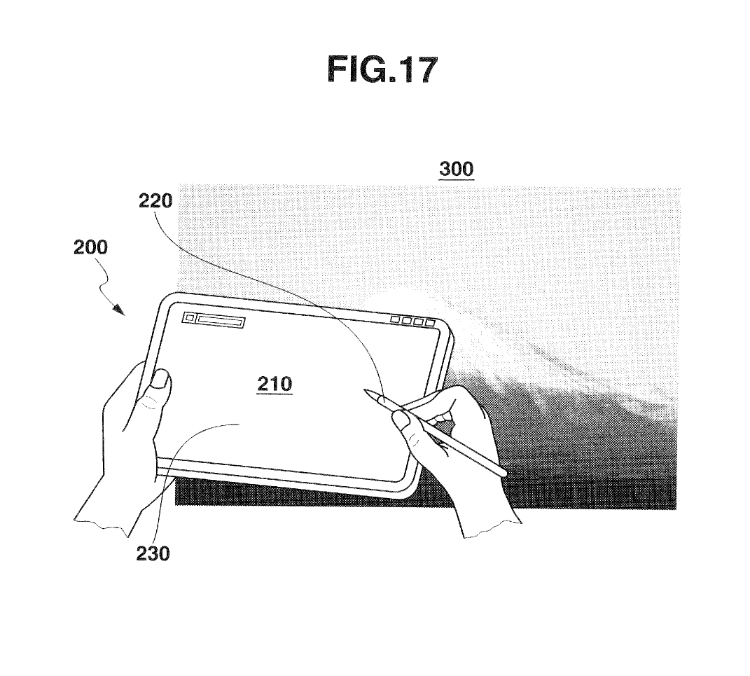

FIG. 17 illustrates an external view of an image processing apparatus 200. An image capturing unit, not shown, provided on the back surface of the image processing apparatus 200 captures an image of a subject 300 and obtains it as an image to be processed. This is lightly displayed on the display device 210 of the image processing apparatus 200, and when a user touches a touch panel 230 provided on the display device 210 with a touch pen 220, the image can be processed as explained in FIGS. 15A, 15B, and 15C.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An image tone changing apparatus comprising:
a selector configured to select a first image imaged by an image pickup device and displayed on a display device as a first rough sketch to serve as a material for an image to be drawn;
an artwork processor configured to process the first rough sketch to change the first rough sketch to a first artwork image with a predetermined tone;
a storage unit configured to store the first artwork image obtained by the artwork processor;
a display controller configured to display on the display device a second image imaged by the image pickup device after the storage unit stores the first artwork image, wherein the selector is configured to select the second image as a second rough sketch to serve as a material for an image to be drawn; and
a rough sketch exchange unit configured to execute a rough sketch exchange by reflecting onto the second rough sketch the processing performed by the art processor on the first rough sketch to obtain the first artwork image, so as to obtain a second artwork image.

2. The image tone changing apparatus according to claim 1, wherein the artwork processor comprises:
a touch area detector configured to detect a touched area of the first rough sketch displayed on the display device; and
a storage configured to store the touched area of the first rough sketch detected by the touch area detector;
wherein the artwork processor is configured to change a tone of the touched area of the first rough sketch detected by the touch area detector to another tone, and to change to another tone a tone of an area of the second rough sketch which corresponds to the touched area of the first rough sketch stored in the storage.

3. The image tone changing apparatus according to claim 1, wherein the artwork processor comprises:
a specified area detector configured to detect specified areas of the first image displayed on the display device;
wherein the artwork processor is configured to respectively change a tone of the specified areas of the first image to other tones.

4. An image tone changing method comprising:
selecting a first image imaged by an image pickup device and displayed on a display device as a first rough sketch to serve as a material for an image to be drawn;
processing the first rough sketch to change the first rough sketch to a first artwork image with a predetermined tone;
storing the first artwork image in a storage unit;
displaying on the display device a second image imaged by the image pickup device after the first artwork image is stored in the storage unit;
selecting the second image as a second rough sketch to serve as a material for an image to be drawn; and executing a rough sketch exchange by reflecting onto the second rough sketch the processing performed on the first rough sketch to obtain the first artwork image, so as to obtain a second artwork image.

5. A non-transitory computer-readable storage medium having stored thereon a computer program which is executable by a computer to control the computer to perform functions comprising:
selecting a first image imaged by an image pickup device and displayed on a display device as a first rough sketch to serve as a material for an image to be drawn;
processing the first rough sketch to change the first rough sketch to a first artwork image with a predetermined tone;
storing the first artwork image in a storage unit;
displaying on the display device a second image imaged by the image pickup device after the first artwork image is stored in the storage unit;
selecting the second image as a second rough sketch to serve as a material for an image to be drawn; and
executing a rough sketch exchange by reflecting onto the second rough sketch the processing performed on the first rough sketch to obtain the first artwork image, so as to obtain a second artwork image.

6. An image tone changing apparatus comprising:
a first capture unit configured to capture a live view image imaged by an image pickup device as a first still image;
a selector configured to select the captured first still image as a first rough sketch to serve as a material for an image to be drawn;
a first display controller configured to display on a display device the first still image selected as the first rough sketch;
an artwork processor configured to gradually process a part of the first rough sketch to change the first rough sketch into a first artwork image by plural touch operations of a user;
a storage unit configured to store the first artwork image obtained by the artwork processor;
a second display controller configured to display on the display device a live view image imaged by the image pickup device after the storage unit stores the first artwork image obtained by the artwork processor;
a second capture unit configured to capture the live view image displayed by the second display controller as a second still image, wherein the selector is configured to select the second still image as a second rough sketch to serve as a material for an image to be drawn; and
a rough sketch exchange unit configured to execute a rough sketch exchange by reflecting onto the second rough sketch the processing performed by the art processor on the first rough sketch to obtain the first artwork image, so as to obtain a second artwork image.

7. An image tone changing method comprising:
capturing a live view image imaged by an image pickup device as a first still image;
selecting the captured first still image as a first rough sketch to serve as a material for an image to be drawn;
displaying on a display device the first still image selected as the first rough sketch;
gradually processing a part of the first rough sketch to change the first rough sketch into a first artwork image by plural touch operations of a user;
storing the first artwork image in a storage unit;
displaying on the display device a live view image imaged by the image pickup device after storing the first artwork image in the storage unit;
capturing the live view image displayed on the display device as a second still image;
selecting the second still image as a second rough sketch to serve as a material for an image to be drawn; and
executing a rough sketch exchange by reflecting onto the second rough sketch the processing performed on the first rough sketch to obtain the first artwork image, so as to obtain a second artwork image.

8. An image tone changing system comprising:
an image pickup device; and
an image tone changing apparatus,
wherein the image pickup device and the image tone changing apparatus are connected to a network,
wherein the image pickup device is configured to sequentially image a live view image, and the image pickup device comprises a transmitter configured to transmit sequentially imaged live view images, and
wherein the image tone changing apparatus comprises:
a receiver configured to receive the live view images transmitted from the transmitter;
a first capture unit configured to capture a live view image received by the receiver as a first still image;
a selector configured to select the captured first still image as a first rough sketch to serve as a material for an image to be drawn;
a first display controller configured to display on a display device the first still image selected as the first rough sketch;
an artwork processor configured to gradually process a part of the first rough sketch to change the first rough sketch into a first artwork image by plural touch operations of a user;
a storage unit configured to store the first artwork image obtained by the artwork processor;
a second display controller configured to display on the display device a live view image imaged by the image pickup device after the storage unit stores the first artwork image obtained by the artwork processor;
a second capture unit configured to capture the live view image displayed by the second display controller as a second still image, wherein the selector is configured to select the second still image as a second rough sketch to serve as a material for an image to be drawn; and
a rough sketch exchange unit configured to execute a rough sketch exchange by reflecting onto the second rough sketch the processing performed by the art processor on the first rough sketch to obtain the first artwork image, so as to obtain a second artwork image.

9. A non-transitory computer-readable storage medium having stored thereon a computer program which is executable by a computer to control the computer to perform functions comprising:
capturing a live view image imaged by an image pickup device as a first still image;
selecting the captured first still image as a first rough sketch to serve as a material for an image to be drawn;
displaying on a display device the first still image selected as the first rough sketch;
gradually processing a part of the first rough sketch to change the first rough sketch into a first artwork image by plural touch operations of a user;
storing the first artwork image in a storage unit;
displaying on the display device a live view image imaged by the image pickup device after storing the first artwork image in the storage unit;
capturing the live view image displayed on the display device as a second still image;
selecting the second still image as a second rough sketch to serve as a material for an image to be drawn; and
executing a rough sketch exchange by reflecting onto the second rough sketch the processing performed on the first rough sketch to obtain the first artwork image, so as to obtain a second artwork image.
